(19) United States
(12) Patent Application Publication
(10) Pub. No.: US 2017/0250402 A1
(43) Pub. Date: Aug. 31, 2017

(54) POSITIVE ELECTRODE ACTIVE MATERIAL FOR LITHIUM ION SECONDARY BATTERY, LITHIUM ION SECONDARY BATTERY POSITIVE ELECTRODE USING THE SAME, AND LITHIUM ION SECONDARY BATTERY

(71) Applicant: TDK CORPORATION, Tokyo (JP)

(72) Inventors: Tetsu SYOJI, Tokyo (JP); Hideaki SEKI, Tokyo (JP)

(73) Assignee: TDK CORPORATION, Tokyo (JP)

(21) Appl. No.: 15/438,133

(22) Filed: Feb. 21, 2017

(30) Foreign Application Priority Data
Feb. 25, 2016 (JP) 2016-034155
Dec. 26, 2016 (JP) 2016-250326

(51) Int. Cl. H01M 4/36; H01M 4/505; H01M 4/62; H01M 4/58; H01M 10/0525; H01M 4/525

(52) U.S. Cl. CPC H01M 4/364; H01M 10/0525; H01M 4/525; H01M 4/625; H01M 4/5825; H01M 4/505

(57) ABSTRACT

A positive electrode active material for a lithium ion secondary battery includes: a first active material selected from active materials represented by composition formula (1); and a second active material represented by composition formula (2). A ratio a/b of an average particle diameter a of the first active material to an average particle diameter b of the second active material is in a range of 1≦a/b≦60.

Li_{w}Niₓ(M1)_{y}(M2)_{z}O₂ (1)

where M1 is at least one element selected from Co and Mn, M2 is at least one element selected from Al, Fe, Cr, Ba, Mn, and Mg, 0.9<w<1.1, 2.0<(x+y+z+w)≦2.1, 0.3<x<0.95, 0.01<y<0.4, and 0.001<z<0.2.

LiₐVOPO₄ (2)

where 0<α≦1.2.

### CROSS-REFERENCE TO RELATED APPLICATION

This application claims priority from Japanese Patent Application Nos. 20164)34155 filed on Feb. 25, 2016, and 2016-250326 filed on Dec. 26, 2016, with the Japan Patent Office the entire contents of which are hereby incorporated by reference.

### BACKGROUND

1. Technical Field

The present disclosure relates to a positive electrode active material for a lithium ion secondary battery, a lithium ion secondary battery positive electrode using the same, and a lithium ion secondary battery.

2. Description of the Related Art

Recent years have seen increasing expectations for widespread use of various electric vehicles, with a view to solving environmental and energy problems. A key to practical application of electric vehicles is a vehicle-mounted power supply, such as motor-driving power supply. As such, lithium ion secondary batteries are being intensive developed. In order for the battery to be widely adopted as a vehicle-mounted power supply, it is very important that the battery have high charging/discharging capacity and high thermal stability.

Currently, as the positive electrode material for lithium ion secondary batteries, lithium cobaltate is generally widely being used. On the other hand, lithium nickelate is known as an active material that provides higher charging/discharging capacity compared with lithium cobaltate. With lithium nickelate, it is possible to achieve high charging/discharging capacity. However, in lithium nickelate, oxygen atoms in the crystal structure are easily released from the crystal. Accordingly, sufficient thermal stability cannot be obtained when, in particular, the lithium nickelate is in a highly charged state.

Meanwhile, according to a technology proposed in JP-A-2004-087299, the surface of lithium nickelate is coated with an olivine compound, which has a small possibility of oxygen release and excellent thermal stability, in this way, improvements in both discharge capacity and stability at high temperature are achieved.

However, according to the method described in JP-A-2004-087299, while stability at high temperature is increased, discharge capacity is decreased by the olivine compound coating. Accordingly, sufficient discharge capacity has not been realized.

### SUMMARY

A positive electrode active material for a lithium ion secondary battery includes: a first active material selected from active materials represented by composition formula (1); and a second active material represented by composition formula (2). A ratio a/b of an average particle diameter a of the first active material to an average particle diameter b of the second active material is in a range of 1≦a/b≦60.

Li_{w}Niₓ(M1)_{y}(M2)_{z}O₂ (1)

where M1 is at least one element selected from Co and Mn, M2 is at least one element selected from Al, Fe, Cr, Ba, Mn, and Mg, 0.9<w<1.1, 2.0<(x+y+z+w)≦2.1, 0.3<x<0.95, 0.01<y<0.4, and 0.001<z<0.2.

LiₐVOPO₄ (2)

where 0<α≦1.2.

### BRIEF DESCRIPTION OF THE DRAWINGS

FIG. 1 is a schematic cross sectional view of a lithium ion secondary battery.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide a positive electrode active material for a lithium ion secondary battery, the material having high discharge capacity and excellent thermal stability, a lithium ion secondary battery positive electrode including the same, and a lithium ion secondary battery.

A positive electrode active material for a lithium ion secondary battery (the present positive electrode active material) according to one aspect of the present disclosure includes: a first active material selected from active materials represented by composition formula (1); and a second active material represented by composition formula (2). A ratio a/b of an average particle diameter a of the first active material to an average particle diameter b of the second active material is in a range of 1≦a/b≦60.

Li_{w}Niₓ(M1)_{y}(M2)_{z}O₂ (1)

where M1 is at least one element selected from Co and Mn, M2 is at least one element selected from Al, Fe, Cr, Ba, Mn, and Mg, 0.9<w<1.1, 2.0<(x+y+z+w)≦2.1, 0.3<x<0.95, 0.01<y<0.4, and 0.001<z<0.2.

LiₐVOPO₄ (2)

where 0<α≦1.2.

When the positive electrode active material includes a plurality of active materials, differences in the timing of deintercalation and intercalation of Li ions that accompany charging and discharging are caused between the active materials due to differences in average potentials of Li deintercalation and intercalation in the respective active materials.

In the combination of the first active material and the second active material used in the present positive electrode active material, the second active material has a higher average potential of lithium deintercalation and intercalation than the first active material. Accordingly, in the second active material, Li ions readily deintercalate in a final period of charging, and Li ions readily intercalate in an initial period of discharging. That is, in the second active material, the time in which Li ions are deintercalated is short. Thus, the Li site of the second active material is not readily substituted with a different cation.

In the second active material, the Li ion travel path is one-dimensional. Accordingly, suppressing of substitution of the Li site by a different cation makes it possible for the Li ions of the second active material to contribute to charging and discharging effectively. Accordingly, discharge capacity can be improved.

Conversely, if the first and the second active materials are combined such that the first active material has a higher average potential of lithium deintercalation and intercalation than the second active material (for example, when the second active material is LiFePO₄), the Li site of the second active material is readily substituted with a different cation. Accordingly, the Li-ion travel path of the second active material will be readily blocked. As a result, Li that cannot be effectively charged or discharged will be produced, thereby causing a significant decrease in discharge capacity.

In the combination of the first active material and the second active material used in the present positive electrode active material, the deintercalation time of the Li ions of the second active material being short also suppresses substitution of the Li ions by a different cation site. In this way, a decrease in oxygen binding force due to substitution of the Li ions of the first active material by a different cation site (for example, Ni site) can be suppressed, whereby thermal stability can also be improved.

In addition, the ratio a/b of the average particle diameter a of the first active material to the average particle diameter b of the second active material is in the range of 1≦a/b≦60. In this way, an increase in contact area of the surface of the first active material and the surface of the second active material can be limited. As a result, high discharge capacity and excellent thermal stability can be obtained.

A ratio c/d of a mass c of the first active material to a mass d of the second active material may be in a range of 1.5≦c/d≦199.

When the ratio c/d of the mass c of the first active material to the mass d of the second active material is in the range of 1.5≦c/d≦199, high discharge capacity possessed by the first active material and high thermal stability possessed by the second active material can be more efficiently obtained.

The present positive electrode active material may include the first active material and the second active material, and may additionally contain a carbon material.

When carbon material is contained, an electron conduction network in the positive electrode active material is formed. In this way, output performance is increased, and higher capacity can be realized.

In the present positive electrode active material, a ratio e/f of a combined mass e of the first active material and the second active material to a mass f of carbon material may be in a range of 4≦e/f≦99.

When the ratio e/f is in the range of 4≦e/f≦99, it becomes possible to increase the density of the lithium ion secondary battery positive electrode using the same while maintaining electron conductivity. Accordingly, even higher capacity can be realized.

According to one aspect of the present disclosure, there are provided a positive electrode active material for a lithium ion secondary battery, the material having high discharge capacity and excellent thermal stability, a lithium ion secondary battery positive electrode including the same, and a lithium ion secondary battery.

In the following, a preferred embodiment of the present disclosure will be described with reference to the drawings. It should be noted, however, that the technology of the present disclosure is not limited to the following embodiment. The constituent elements described below include those that a person skilled in the art could readily conceive of, and those substantially identical thereto. The constituent elements described below may be combined as appropriate.

### <Lithium Ion Secondary Battery>

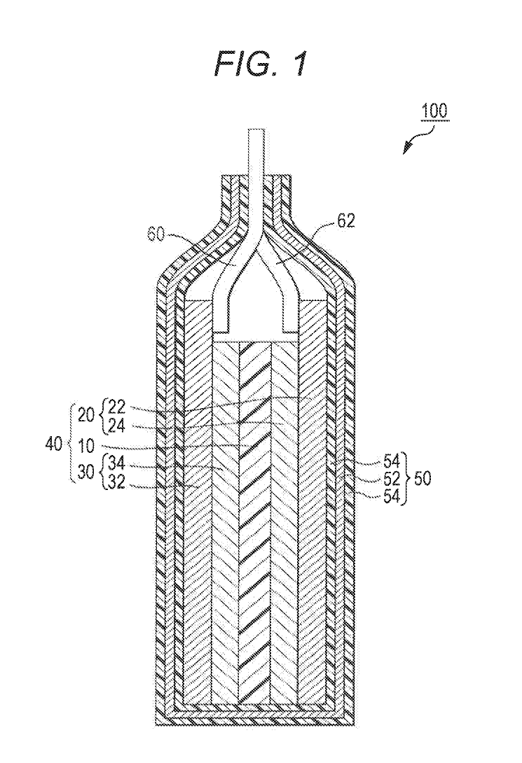

In the following, the constituent members will be described in detail with reference to a lithium ion secondary battery by way of example. FIG. 1 is a schematic cross sectional view of the lithium ion secondary battery according to the present embodiment. As illustrated in FIG. 1, the lithium ion secondary battery 100 is provided with a positive electrode 20; a negative electrode 30 opposing the positive electrode 20; a separator 10; and an electrolytic solution (not illustrated) with which at least the separator is impregnated. The separator 10 is interposed between the positive electrode 20 and the negative electrode 30, and is in contact with a major surface of the positive electrode 20 and a major surface of the negative electrode 30.

The lithium ion secondary battery 100 is mainly provided with a power generating element 40; a case 50 that houses the power generating element 40 in sealed state; and a pair of leads 60, 62 connected to the power generating element 40.

In the power generating element 40, the pair of the positive electrode 20 and the negative electrode 30 is disposed opposing each other across the battery separator 10. The positive electrode 20 is provided with a sheet (film) of positive electrode current collector 22, and a positive electrode active material layer 24 disposed on the positive electrode current collector 22. The negative electrode 30 is provided with a sheet (film) of negative electrode current collector 32, and a negative electrode active material layer 34 disposed on the negative electrode current collector 32. The major surface of the positive electrode active material layer 24 and the major surface of the negative electrode active material layer 34 are respectively in contact with major surfaces of the battery separator 10. The leads 62, 60 are respectively connected to ends of the positive electrode current collector 22 and the negative electrode current collector 32. Ends of the leads 60, 62 extend to the outside of the case 50.

In the power generating element 40, the positive electrode 20 and the negative electrode 30 may be wound spirally, folded, or overlapping each other with the separator 10 interposed therebetween.

Hereafter, the positive electrode 20 and the negative electrode 30 may be generally referred to as electrodes 20, 30. The positive electrode current collector 22 and the negative electrode current collector 32 may be generally referred to as current collectors 22, 32. The positive electrode active material layer 24 and the negative electrode active material layer 34 may be generally referred to as active material layers 24, 34.

### <Positive Electrode>

The positive electrode current collector 22 is an electrically conductive sheet material, for example. As the positive electrode current collector 22, a metal thin plate of aluminum, copper, or nickel foil may be used.

The positive electrode active material layer 24 is mainly composed of a positive electrode active material, a binder, and a required amount of conductive auxiliary agent.

A positive electrode active material according to the present embodiment includes: a first active material selected from active materials represented by composition formula (1); and a second active material represented by composition formula (2). A ratio a/b of an average particle diameter a of the first active material to an average particle diameter b of the second active material is in a range of 1≦a/b≦60.

Li_{w}Niₓ(M1)_{y}(M2)_{z}O₂ (1)

where M1 is at least one element selected from Co and Mn, M2 is at least one element selected from Al, Fe, Cr, Ba, Mn, and Mg, 0.9<w<1.1, 2.0<(x+y+z+w)≦2.1, 0.3<x<0.95, 0.01<y<0.4, and 0.001<z<0.2.

LiₐVOPO₄ (2)

where 0<α≦1.2.

The positive electrode active material according to the present embodiment includes the first active material and the second active material and the ratio is in the range of 1≦a/b≦60. In this way, the contact area of the first active material and the second active material is controlled, whereby the second active material can be efficiently charged and discharged. In addition, because the contact area of the first active material and the electrolyte solution is decreased, oxygen release is suppressed. Accordingly, thermal stability can be increased,

Furthermore, the ratio a/b of the average particle diameter a of the first active material to the average particle diameter b of the second active material may be in a range of 1.3≦a/b≦5. In this way, in particular, both high discharge capacity and excellent thermal stability can be achieved.

Specific examples of the first active material in the present embodiment include Li_{1.0}Ni_{0.8}Co_{0.15}Al_{0.05}O₂, Li_{1.0}Ni_{0.83}Co_{0.14}Al_{0.03}O₂, Li_{1.0}Co_{0.1}Mn_{0.1}O₂, Li_{1.0}Ni_{0.5}Co_{0.2}Mn_{0.3}O₂, Li_{1.0}Ni_{0.6}Co_{0.2}Mn_{0.2}O₂, and Li_{1.0}Ni_{0.33}Co_{0.33}Mn_{0.33}O₂. Among others, Li_{1.0}Ni_{0.8}Co_{0.15}Al_{0.05}O₂ may be used as the first active material. In this way, high capacity can be obtained.

The composition ratios of the elements constituting the first active material are not limited to the above-described compositions. For example, when an element that varies by about 3% is included, or when the composition ratios of the respective elements are somewhat different, similarly high capacity can be obtained.

A primary particle diameter of the first active material in the present embodiment may be in a range of from 0.3 to 5 μm.

The first active material may form secondary particles, of which a secondary particle diameter may be in a range of from not less than 7 μm and not more than 30 μm.

A specific example of the second active material is LiVOPO₄.

The crystal form of LiₐVOPO₄ as the second active material is not particularly limited. A part of the compound represented by LiₐVOPO₄ may be in amorphous state. In particular, the crystal form of the compound represented by LiₐVOPO₄ may be in the orthorhombic system.

In the second active material, a part of element V may be substituted by one or more elements selected from the group consisting of Ti, Ni, Co, Mn, Fe, Zr, Cu, Zn, and Yb.

A primary particle diameter of the second active material may be in a range of from 0.05 to 1 μm.

The second active material may form secondary particles, of which a secondary particle diameter may be in a range of from not less than 1 μm and not more than 5 μm.

The first active material and the second active material may be uniformly mixed in the positive electrode active material layer.

The primary particle diameter and the secondary particle diameter in the present embodiment are particle diameters (average particle diameters) defined by a fixed-direction diameter in a scanning electron microscope (SEM) photograph. The average particle diameter of the primary particle diameter is obtained by measuring the fixed-direction diameters of 50 to 200 primary particles in an SEM photograph, and determining an average value of a cumulative distribution of the measured fixed-direction diameters. The average particle diameter of the secondary particle diameter is obtained by measuring the fixed-direction diameters of 50 to 200 secondary particles in an SEM photograph, and determining an average value of a cumulative distribution of the measured fixed-direction diameters.

In the present embodiment, the average particle diameter a of the first active material, and the average particle diameter b of the second active material may be the diameter of either the primary particle or secondary particle thereof For calculating the ratio a/b, the primary particles of the first active material and the second active material, or the secondary particles of the first active material and the second active material may be used.

In the present embodiment, a/b may be a value calculated using the average particle diameter of the primary particles of the first active material, and the average particle diameter of the primary particles of the second active material.

The ratio c/d of the mass c of the first active material to the mass d of the second active material may be in a range of 1.5≦c/d≦199. In this way, the high charging/discharging capacity possessed by the first active material, and the high thermal stability possessed by the second active material can be obtained more efficiently.

The positive electrode active material for a lithium ion secondary battery according to the present embodiment may include the first active material and the second active material, and may furthermore contain carbon material.

By containing carbon material, an electron conduction network in the positive electrode active material is formed. In this way, output performance is increased, and higher capacity can be realized.

Examples of the carbon material include graphite, carbon black, acetylene black, Ketjen black, and carbon fiber. By using these carbon materials, satisfactory conductivity of the positive electrode active material layer 24 can be obtained.

In the present embodiment, the ratio e/f of the combined mass e of the first active material and the second active material and the mass f of carbon material may be in a range of 4≦e/f≦99.

When the ratio e/f is in the range of 4≦e/f≦99, it becomes possible to increase the density of the lithium ion secondary battery positive electrode using the same, while maintaining electron conductivity. Accordingly, even higher capacity can be realized.

### <Conductive Auxiliary Agent>

The conductive auxiliary agent is not particularly limited and may be a known conductive auxiliary agent as long as it increases the conductivity of the positive electrode active material layer 24. Examples of the conductive auxiliary agent include carbon black such as acetylene black, furnace black, channel black, and thermal black; carbon fibers such as vapor-grown carbon fiber (VGCF), and carbon nanotubes; and carbon material such as graphite. As the conductive auxiliary agent, one or more of the above examples may be used.

The content of the conductive auxiliary agent in the positive electrode active material layer 24 is also not particularly limited. When the conductive auxiliary agent is added into the positive electrode active material layer 24, the content of the conductive auxiliary agent may normally be 1 mass % to 10 mass % with reference to the sum of the masses of the positive electrode active material, the conductive auxiliary agent, and the binder.

### (Binder)

The binder binds the active materials and also binds the active materials with the current collector 22. The binder may be any binder capable of achieving the above binding. Examples of the binder include fluorine resin such as polyvinylidene fluoride (PVDF), polytetrafluoroethylene (PTFE), tetrafluoroethylene/hexafluoropropylene copolymer (FEP), tetrafluoroethylene/perfluoro alkyl vinyl ether copolymer (PFA), ethylene/tetrafluoroethylene copolymer (ETFE), polychiorotrifluoroethylene (PCTFE), ethylene/chlorotrifluoroethylene copolymer (ECTFE), and polyvinyl fluoride (PVF).

Other than the above examples, vinylidene fluoride fluorine rubber may be used as the binder. Examples of fluorine rubber based on vinylidene fluoride include fluorine rubber based on vinylidene fluoride/hexafluoropropylene (VDF/HFP-based fluorine rubber), fluorine rubber based on vinylidene fluoride/hexafluoropropylene/tetrafluoroethylene (VDF/HFPTFE-based fluorine rubber), fluorine rubber based on vinylidene fluoride/pentafluoropropylene (VDF/PFP-based fluorine rubber), fluorine rubber based on vinylidene fluoride/pentafluoropropylene/tetrafluoroethylene (VDF/PFP/TFE-based fluorine rubber), fluorine rubber based on vinylidene fluoride/perfluoromethyl vinyl ether/tetrafluoroethylene (VDF/PFMVE/TFE-based fluorine rubber), and fluorine rubber based on vinylidene fluoride/chlorotrifluoroethylene (VDF/CTFE-based fluorine rubber).

In addition to the above, examples of the binder that may be used include polyethylene, polypropylene, polyethylene terephthalate, aromatic polyamide, cellulose, styrene-butadiene rubber, isoprene rubber, butadiene rubber, and ethylene-propylene rubber. Other examples of the binder that may be used include thermoplastic elastomeric polymers such as styrene-butadiene-styrene block copolymers, hydrogen additives thereof, styrene-ethylene-butadiene-styrene copolymers, styrene-isoprene-styrene block copolymers, and hydrogen additives thereof. Yet other examples of the binder that may be used include syndiotactic 1,2-polybutadiene, ethylene-vinyl acetate copolymers, and propylene/α-olefin (having a carbon number of 2 to 12) copolymers.

As the hinder, a conductive polymer having electron conductivity or a conductive polymer having ion conductivity may be used. An example of the conductive polymer having electron conductivity is polyacetylene.

As the conductive polymer having ion conductivity, a conductive polymer having ion conductivity with respect to lithium ion and the like may be used, for example. An example of the conductive polymer is a complex of a polymer compound monomer and a lithium salt or an alkali metal salt composed mainly of lithium. Examples of the monomer include polyether-based polymer compounds such as polyethylene oxide and polypropylene oxide; crosslinked polymers of polyether compounds; polyepichlorohydrin; polyphosphazene; polysiloxane; polyvinylpyrrolidone; polyvinylidene carbonate; and polyacrylonitrile. Examples of the lithium salt or alkali metal salt composed mainly of lithium include LiClO₄, LiBF₄, LiPF₆, LiAsF₆, LiCl, LiBr, Li(CF₃SO₂)₂N, and LiN(C₂F₅SO₂)₂. Examples of the polymerization initiator used for complexing include photopolymerization initiators or thermal polymerization initiators adapted for the monomer.

The binder content in the positive electrode active material layer 24 is not particularly limited. The binder content may be 1 mass % to 15 mass % or 3 mass % to 10 mass % with reference to the sum of the masses of the active material, the conductive auxiliary agent, and the binder. When the binder content in the positive electrode active material layer 24 is in the above ranges, it becomes possible to suppress the tendency of failure to form a strong active material layer due to too little an amount of the binder in the obtained electrode active material layer 24. It also becomes possible to suppress the tendency of difficulty in obtaining a sufficient volume energy density due to an increase in the amount of binder that does not contribute to electric capacity.

### <Negative Electrode>

The negative electrode current collector 32 is an electrically conductive sheet material, for example. Examples of the material of the negative electrode current collector 32 include metal thin plates of aluminum, copper, and nickel foils.

The negative electrode active material layer 34 is mainly composed of a negative electrode active material, a binder, and a required amount of conductive auxiliary agent.

The negative electrode active material is not particularly limited as long as it is capable of reversibly proceeding absorption and desorption of lithium ion, intercalation and deintercalation of lithium ion, or doping and undoping of lithium ion and counter anion of the lithium ion (for example, ClO₄⁻). As the negative electrode active material, known negative electrode active materials used in lithium ion secondary batteries may be used. Examples of the negative electrode active material include carbon materials such as natural graphite, synthetic graphite, mesocarbon micro beads, mesocarbon fiber (MCF), soaks, glasslike carbon, and organic compound fired material; metals that can be combined with lithium, such as Al, Si, and Sn; amorphous compounds composed mainly of oxides such as SiO₂ and SnO₂; and lithium titanate (Li₄Ti₅O₁₂).

As the binder and conductive auxiliary agent, the same material as the aforementioned material used for the binder in the positive electrode 20 may be used. As to the binder content too, the same content as the aforementioned binder content in the positive electrode 20 may be adopted.

### <Separator>

The separator 10 may be formed from a material that has electrically insulating porous structure. Examples of the material include a single-layer body or a stacked body of polyethylene, polypropylene or polyolefin films; an extended film of a mixture of the aforementioned resins; and a fibrous nonwoven fabric including at least one constituent material selected from the group consisting of cellulose, polyester, and polypropylene.

### <Electrolyte Solution>

The electrolytic solution is contained in the positive electrode active material layer 24, the negative electrode active material layer 34, and the battery separator 10. The electrolytic solution is not particularly limited. For example, in the present embodiment, an electrolytic solution (such as electrolytic aqueous solution and electrolytic solution using organic solvent) containing lithium salt may be used. However, in the case of electrolytic aqueous solution, the electro-chemical decomposition voltage is low, and the withstand voltage at the time of charging is limited to a low voltage. Accordingly, the electrolytic solution may be an electrolytic solution that contains organic solvent (nonaqueous electrolytic solution). The electrolytic solution that is used may be obtained by dissolving lithium salt in a nonaqueous solvent (organic solvent). Examples of the lithium salt that may be used include salts such as LiPF₆, LiClO₄, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO )₂, and LiBOB. The salts may be used individually or in a combination of two or more salts.

Examples of the organic solvent include propylene carbonate, ethylene carbonate, and diethyl carbonate. The organic solvents may be used individually or in a mixture of two or more organic solvents mixed in any desired ratio.

### <Case>

The case 50 encases the power generating element 40 and the electrolytic solution in a sealed manner. The case 50 is not particularly limited as long as it is capable of reducing leakage of electrolytic solution to the outside, intrusion of water and the like into the lithium ion secondary battery 100 from the outside, and the like. For example, as the case 50, as illustrated in FIG. 1, a metal laminate film including a metal foil 52 and a polymer film 54 coating the metal foil 52 on both sides may he utilized. For example, an aluminum foil may be used as the metal foil 52, and a film of polypropylene and the like may be used as the polymer film 54. For example, the material of the outer polymer film 54 may be a polymer with a high melting point, such as polyethylene terephthalate (PET) and polyamide. The material of the inner polymer film 54 may be polyethylene (PE), polypropylene (PP) and the like.

### <Leads>

The leads 60, 62 are formed from a conductive material such as aluminum and nickel.

The lithium ion secondary battery 100 may be manufactured as described below. First, the leads 62, 60 are respectively welded onto the positive electrode current collector 22 and the negative electrode current collector 32 by known method. Between the positive electrode active material layer 24 of the positive electrode 20 and the negative electrode active material layer 34 of the negative electrode 30, the battery separator 10 is interposed. In this state, the positive electrode 20, the negative electrode 30, and the battery separator 10 are inserted into the case 50 together with the electrolytic solution, and then the entry of the case 50 is sealed.

The electrodes 20, 30 may be fabricated by a method normally used, as follows. First, a paint including active material, binder, solvent, and conductive auxiliary agent is coated on the current collectors. Thereafter, the solvent in the paint with which the current collectors have been coated is removed.

Examples of the solvent that may be used include N-methyl-2-pyrrolidone and N,N-dimethylformamide.

The coating method is not particularly limited, and a method normally adopted for electrode fabrication may be used. Examples of the coating method include slit die-coating method and doctor blade method.

The method for removing the solvent from the paint with which the current collectors 22, 23 are coated is not particularly limited. In order to remove the solvent, the current collectors 22, 23 with the paint coated thereon are dried in an atmosphere of 80° C. to 150° C., for example.

The electrodes on which the active material layers 24, 34 have been formed as described above may then be subjected to a press process as needed, using a roll press device and the like, for example. The linear pressure of the roll press may be 100 to 1500 kgf/cm, for example.

Through the above steps, the electrodes 20, 30 can be fabricated.

Next, a method for manufacturing the positive electrode active material will be described.

The method for manufacturing the first active material is not particularly limited. The manufacturing method includes at least a raw-material preparation step and a firing step. The raw-material preparation step may include, for example, compounding a predetermined lithium source and metal source so that the molar ratio according to composition formula (1) is satisfied, followed by pulverizing/mixing, thermal decomposition/mixing, precipitation reaction, or hydrolysis.

The method for manufacturing the second active material is not particularly limited. The manufacturing method includes at least a raw-material preparation step and a firing step. In the raw-material preparation step, a lithium source, a vanadium source, a phosphorus source, and water are stirred and mixed to prepare a mixture (liquid mixture). A drying step of drying the mixture obtained in the raw-material preparation step may be implemented before the firing step. As needed, a hydrothermal synthesis step may be implemented before the drying step and the firing step.

The compounding ratios of the lithium source, vanadium source and phosphorus source are adjusted by, for example, making the molar ratios of Li, V, and P in the mixture correspond to the stoichiometric proportion (1:1:1) of LiVOPO₄. The second active material may be manufactured by drying and firing the mixture. The lithium amount of the LiₐVOPO₄ can be adjusted by causing electric chemical deintercalation of Li from the obtained LiVOPO₄.

Alternatively, the second active material may be manufactured by subjecting VOPO₄ and a lithium source to a mixing and heating treatment. VOPO₄ may be manufactured as described below, for example. A phosphorus source, a vanadium source, and distilled water are stirred to prepare a mixture thereof. The mixture is dried to manufacture VOPO₄.2H₂O which is a hydrate. VOPO₄.2H₂O is further subjected to a heat treatment to manufacture VOPO₄.

The compound form of the metal source, lithium source, vanadium source, and phosphorus source is not particularly limited. Depending on the process, known material such as oxides and salts of the individual raw-materials may be selected.

In order to obtain a powder of active material that has a desired particle diameter, a pulverizer or a classifier may be used. Examples of the pulverizer and classifier include a mortar, a ball mill, a bead mill, a sand mill, a vibration ball mill, a planetary ball mill, a jet mill, a counter-jet mill, a swirling-airflow jet mill, and a sieve. For pulverization, wet pulverizing using water or an organic solvent such as hexane may be used. The classification method is not particularly limited. For both dry pulverizing and wet pulverizing, a sieve, a wind power classifier and the like may be used as needed.

For manufacturing the positive electrode active material, the first active material and the second active material are weighed at predetermined ratios and mixed as needed. The mixing method is not particularly limited. For the mixing, a known device ay be used. Specifically, a powder mixer such as a mortar, a V-type mixer, a S-type mixer, an automated mortar, a ball mill, or a planetary ball mill may be used for dry or wet mixing.

In addition, in the present embodiment, the positive electrode active material for lithium ion secondary battery obtained by the mixing method may be fired in an argon atmosphere, an air atmosphere, an oxygen atmosphere, a nitrogen atmosphere, or a mixed atmosphere thereof.

The firing temperature is not particularly limited as long as the temperature is such that the first active material and the second active material do not become altered or decomposed. For example, the tiring temperature may be in a temperature range of 100° C. to 650° C.

In the foregoing, the positive electrode active material for a lithium ion secondary battery, the lithium ion secondary battery positive electrode using the same, and the lithium ion secondary battery according to a preferred embodiment of the present embodiment have been described in detail. However, the technology according to the present disclosure is not limited to the embodiment,

### EXAMPLES

In the following, the technology of the present disclosure will be described in more concrete terms with reference to examples and comparative examples. The technology of the present disclosure, however, is not limited to the following examples,

### Example 1

### (1) Fabrication of Positive Electrode

For fabricating the positive electrode active material, a lithium nickel complex oxide (Li_{1.01}Ni_{0.8}Co_{0.15}Al_{0.05}O₂) was used as the first active material indicated by the composition formula (1). In addition, as the second active material, LiVOPO₄ in the orthorhombic system was used. By weighing the first active material and the second active material at a mass ratio of 80:20 and mixing them using a mortar, the positive electrode active material was fabricated. In Example 1, the average particle diameter a of the first active material was 5 μm, and the average particle diameter b of the second active material was 0.05 μm. In Example 1, as the average particle diameters a and b, the values of the respective average primary particle diameters of the first active material and the second active material were used. Then, by dispersing 90 parts by mass of powder of the positive electrode active material, 5 parts by mass of acetylene black, and 5 parts by mass of polyvinylidene fluoride (PVDF) in N-methyl-2-pyrrolidone (NMP), a slurry was prepared. The obtained slurry was coated on an aluminum foil with a thickness of 20 μm. The aluminum foil with the slurry coated thereon was dried at a temperature of 140°C. for 30 minutes, and then pressed using a roll press device at a linear load of 1000 kgf/cm. In this way, the positive electrode was obtained.

The cross section of the obtained positive electrode was observed using a SEM. As a result, the average particle diameter a of the first active material and the average particle diameter b of the second active material were the same as those at the time of mixing.

### (2) Fabrication of Negative Electrode

Ninety parts by mass of a natural graphite powder as the negative electrode active material and 10 parts by mass of PVDF were dispersed in NMP, thereby preparing a slurry. The obtained slurry was coated on a copper foil with a thickness of 15 μm. The copper foil with the slurry coated thereon was dried at reduced pressure at a temperature of 140° C. for 30 minutes, and was then subjected to a press process using a roil press device. In this way, the negative electrode was obtained.

### (3) Nonaqueous Electrolytic Solution

Into a mixed solvent of ethylene carbonate (EC) and diethyl carbonate (DEC), LiPF₆ was dissolved to achieve 1.0 mol/L, thereby obtaining a nonaqueous electrolytic solution. The volume ratio of EC and DEC in the mixed solvent was EC:DEC=30: 70.

### (4) Separator

A macroporous polyethylene film (pore ratio: 40%, shut-down temperature: 134° C.) with a film thickness of 20 μm was prepared.

### (5) Fabrication of Battery

A power generating element was constructed by laminating the positive electrode, the negative electrode, and the separator. Using the power generating element and the nonaqueous electrolytic solution, a battery cell of Example 1 was fabricated.

### (Measurement of Discharge Capacity)

Using the battery cell of Example 1 fabricated as described above, charging was performed at a constant current density of 0.1 C until a charge cut-off voltage became 4.2 V (vs. Li/Li⁺). Further, constant-voltage charging was performed at a constant voltage of 4.2 V (vs. Li/Li⁺) Until the current density decreased to 0.05 C. In this way, the initial charge capacity measured. With regard to the current density, the initial charge capacity was measured on the assumption that 1 C was 190 mAh/g.

After a 10-minute intermission, discharging was performed at a constant current density of 0.1 C until the discharge cut-off voltage became 2.8 V (vs. Li/Li⁺). Thereafter, the initial discharge capacity of the battery was measured. The results are shown in a table below.

### (Measurement of Heat Generating Peak)

By focusing on heat generating peak, the thermal stability of the positive electrode active material for a lithium ion secondary battery can be evaluated. The measurement of the heat generating peak was performed by the following method.

Charging was performed at a constant current density of 0.1 C until the charge cut-off voltage became 4.2 V (vs. Li/Li⁺). Further, constant-voltage charging was performed at a constant voltage of 4.2 V (vs. Li/Li³⁰ ) until the current density decreased to 0.05 C. After a 10-minute intermission, discharging was performed at a constant current density of 0.1 C until the discharge cut-off voltage became 2.8 V (vs. Li/Li⁺). The cycle of charging and discharging including the charging at the constant current density of 0.1 C, the constant-voltage charging, the 10-minute intermission, and the discharging at the constant current density of 0.1 C was performed twice in total. Thereafter, charging was performed at a constant current density of 0.1 C until the charge cut-off voltage became 4.2 V (vs. Li/Li⁺). Further, constant-voltage charging was performed at a constant voltage of 4.2 V (vs. Li/Li⁺) until the current density decreased to 0.05 C, thereby fully charging the battery.

With the battery fully charged, the laminate was opened to remove the electrode, and the electrode was washed with diethyl carbonate (DEC). Thereafter, the electrode was dried for 15 minutes.

After drying, the active material layer was peeled from the electrode using ceramic tweezers, thereby obtaining from the active material layer an active material powder with a weight of 5 mg. The powder was put into a container for heat quantity measurement. Thereafter, 3 μL of nonaqueous electrolytic solution was injected into the container using a micropipette.

The container thus prepared was set on a calorimeter, and the temperature was increased from 30° C. to 500° C. at a temperature rise rate of 5.0° C./min to examine the peak height of a main heat generating peak (heat generating peak strength).

The heat generating peak strength of the battery cell of Example 1 was considered 100. The heat generating peak strengths of battery cells other than that of Example 1, as will be described below, are indicated with index numbers with reference to the heat generating peak strength of 100 of the battery cell of Example 1, as shown in the following tables.

When the heat generating peak strength is small, heat generating reaction is suppressed, so that it can be said that the thermal stability of the battery cell is high. Accordingly, also with regard to the index numbers with reference to the heat generating peak strength 100 of the battery cell of Example 1, small values mean that the thermal stability of the battery cell is high.

The batteries of which the discharge capacity was not less than 180 mAh/g and the heat generating peak strength was not more than 125% were evaluated to be “A”. The batteries of which the discharge capacity was less than 180 mAh/g or the heat generating peak strength was greater than 125% were evaluated to be “F”. The evaluations of the batteries according to Examples and Comparative Examples are shown in the following tables.

### Examples 2 to 9, Comparative Examples 1 to 3

In Examples 2 to 9 and Comparative Examples 1 to 3, the battery cell was fabricated and evaluated by the same method as in Example 1 with the exception that the ratio of the average particle diameter a of the first active material to the average particle diameter b of the second active material was modified. The average particle diameters of the first active material and the second active material were obtained by randomly extracting respectively 100 particles from each SEM photograph, measuring particle diameters of the particles, and then calculating their average value. The results are shown in Table 1.

TABLE 1

| | | | | | | | Heat | |
|---|---|---|---|---|---|---|---|---|
| | | Second | | | | Discharge | generating | |
| | | active | | a | b | capacity | peak | |
| | First active material | material | a/b | [μm] | [μm] | [mAh/g] | intensity | Decision |
| Comparative | Li_{1.01}Ni_{0.8}Co_{0.15}Al_{0.05}O₂ | LiVOPO₄ | 100 | 5 | 0.05 | 160 | 158 | F |
| Example 1 | | | | | | | | |
| Comparative | Li_{1.01}Ni_{0.8}Co_{0.15}Al_{0.05}O₂ | LiVOPO₄ | 80 | 4 | 0.05 | 170 | 150 | F |
| Example 2 | | | | | | | | |
| Example 2 | Li_{1.01}Ni_{0.8}Co_{0.15}Al_{0.05}O₂ | LiVOPO₄ | 60 | 3 | 0.05 | 184 | 117 | A |
| Example 3 | Li_{1.01}Ni_{0.8}Co_{0.15}Al_{0.05}O₂ | LiVOPO₄ | 30 | 1.8 | 0.06 | 185 | 119 | A |
| Example 4 | Li_{1.01}Ni_{0.8}Co_{0.15}Al_{0.05}O₂ | LiVOPO₄ | 10 | 1 | 0.1 | 185 | 116 | A |
| Example 5 | Li_{1.01}Ni_{0.8}Co_{0.15}Al_{0.05}O₂ | LiVOPO₄ | 5 | 1 | 0.2 | 191 | 99 | A |
| Example 1 | Li_{1.01}Ni_{0.8}Co_{0.15}Al_{0.05}O₂ | LiVOPO₄ | 3 | 0.9 | 0.3 | 192 | 100 | A |
| Example 6 | Li_{1.01}Ni_{0.8}Co_{0.15}Al_{0.05}O₂ | LiVOPO₄ | 2 | 0.8 | 0.4 | 192 | 100 | A |
| Example 7 | Li_{1.01}Ni_{0.8}Co_{0.15}Al_{0.05}O₂ | LiVOPO₄ | 1.3 | 0.65 | 0.5 | 193 | 99 | A |
| Example 8 | Li_{1.01}Ni_{0.8}Co_{0.15}Al_{0.05}O₂ | LiVOPO₄ | 1.1 | 0.55 | 0.5 | 184 | 119 | A |
| Example 9 | Li_{1.01}Ni_{0.8}Co_{0.15}Al_{0.05}O₂ | LiVOPO₄ | 1 | 0.6 | 0.6 | 183 | 125 | A |
| Comparative | Li_{1.01}Ni_{0.8}Co_{0.15}Al_{0.05}O₂ | LiVOPO₄ | 0.75 | 0.45 | 0.6 | 175 | 200 | F |
| Example 3 | | | | | | | | |

From Table 1, it is seen that when the ratio a/b of the average particle diameter a of the first active material to the average particle diameter b of the second active material is in a range of 1≦a/b≦60, high discharge capacity was obtained and heat generating peak strength was small. When the ratio a/b was outside the range of 1 a/b≦60, discharge capacity was decreased, and the heat generating peak strength was increased.

### Examples 10 to 13, Examples 30 to 33, Comparative Examples 9 to 11

In Examples 10 to 13, Examples 30 to 33, and Comparative Examples 9 to 11, the battery cell was fabricated and evaluated by the same method as in Example 1 with the exception that the ratio of the mass c of the first active material to the mass d of the second active material was modified. The results are shown in Table 2.

TABLE 2

| | | | | Mass ratio of | Mass ratio of | | | |
|---|---|---|---|---|---|---|---|---|
| | | | | first active | second active | | | |
| | | | | material to | material to | | | |
| | | | | entire postive | entire positive | | | |
| | | | | electrode | electrode | | Heat | |
| | | Second | | active | active | Discharge | generating | |
| | | active | | material | material | capacity | peak | |
| | First active material | material | c/d | [wt %] | [wt %] | [mAh/g] | intensity | Decision |
| Comparative | Li_{1.01}Ni_{0.8}Co_{0.15}Al_{0.05}O₂ | LiVOPO₄ | 1 | 50 | 50 | 165 | 126 | F |
| Example 9 | | | | | | | | |
| Comparative | Li_{1.01}Ni_{0.8}Co_{0.15}Al_{0.05}O₂ | LiVOPO₄ | 1.22 | 55 | 45 | 173 | 125 | F |
| Example 10 | | | | | | | | |
| Example 10 | Li_{1.01}Ni_{0.8}Co_{0.15}Al_{0.05}O₂ | LiVOPO₄ | 1.5 | 60 | 40 | 188 | 100 | A |
| Example 11 | Li_{1.01}Ni_{0.8}Co_{0.15}Al_{0.05}O₂ | LiVOPO₄ | 2.33 | 70 | 30 | 189 | 98 | A |
| Example 12 | Li_{1.01}Ni_{0.8}Co_{0.15}Al_{0.05}O₂ | LiVOPO₄ | 9 | 90 | 10 | 196 | 107 | A |
| Example 13 | Li_{1.01}Ni_{0.8}Co_{0.15}Al_{0.05}O₂ | LiVOPO₄ | 19 | 95 | 5 | 194 | 110 | A |
| Example 30 | Li_{1.01}Ni_{0.8}Co_{0.15}Al_{0.05}O₂ | LiVOPO₄ | 32.33 | 97 | 3 | 194 | 111 | A |
| Example 31 | Li_{1.01}Ni_{0.8}Co_{0.15}Al_{0.05}O₂ | LiVOPO₄ | 99 | 99 | 1 | 193 | 111 | A |
| Example 32 | Li_{1.01}Ni_{0.8}Co_{0.15}Al_{0.05}O₂ | LiVOPO₄ | 142 | 99.3 | 0.7 | 191 | 112 | A |
| Example 33 | Li_{1.01}Ni_{0.8}Co_{0.15}Al_{0.05}O₂ | LiVOPO₄ | 199 | 99.5 | 0.5 | 187 | 122 | A |
| Comparative | Li_{1.01}Ni_{0.8}Co_{0.15}Al_{0.05}O₂ | LiVOPO₄ | 499 | 99.8 | 0.2 | 180 | 187 | F |
| Example 11 | | | | | | | | |

From Table 2, it is seen that when the ratio c/d of the mass c of the first active material and the mass d of the second active material was in a range of 1.5≦c/d≦199, high discharge capacity was obtained and heat generating peak strength was small.

### Comparative Examples 4 to 6

In Comparative Examples 4 to 6, the battery cell was fabricated and evaluated by the same method as in Example 1 with the exception that the second active material of the positive electrode active material was modified. The results are shown in Table 3.

TABLE 3

| | | | | | | Heat | |
|---|---|---|---|---|---|---|---|
| | | Second | | | Discharge | generating | |
| | | active | | | capacity | peak | |
| | First active material | material | a/b | c/d | [mAh/g] | intensity | Decision |
| Comparative Example 4 | Li_{1.01}Ni_{0.8}Co_{0.15}Al_{0.05}O₂ | LiFePO₄ | 3 | 4 | 173 | 151 | F |
| Comparative Example 5 | Li_{1.01}Ni_{0.8}Co_{0.15}Al_{0.05}O₂ | LiCoPO₄ | 3 | 4 | 163 | 135 | F |
| Comparative Example 6 | Li_{1.01}Ni_{0.8}Co_{0.15}Al_{0.05}O₂ | LiNiPO₄ | 3 | 4 | 160 | 142 | F |

From Table 3, it is seen that when LiFePO₄, LiCoPO₄, or LiNiPO₄ was used as the second active material, sufficient discharge capacity was not obtained, and heat generating peak strength was increased.

### Examples 14 to 21

In Examples 14 to 17, the battery cell was fabricated and evaluated by the same method as in Example 1 with the exception that the first active material was modified. In Examples 18 to 21, the battery cell was fabricated and evaluated by the same method as in Example 1 with the exception that the first active material was modified, and that the ratio a/b of the average particle diameter a of the first active material to the average particle diameter b of the second active material, and the ratio c/d of the mass c of the first active material to the mass d of the second active material were modified as appropriate. The results are shown in Table 4.

TABLE 4

| | | | | | | | Heat | |
|---|---|---|---|---|---|---|---|---|
| | | Second | | | | Discharge | generating | |
| | | active | | a | | capacity | peak | |
| | First active material | material | a/b | [μm] | c/d | [mAh/g] | intensity | Decision |
| Example 14 | Li_{1.01}Ni_{0.81}Co_{0.15}Al_{0.01}O₂ | LiVOPO₄ | 3 | 0.9 | 4 | 192 | 105 | A |
| Example 15 | Li_{1.01}Ni_{0.86}Co_{0.1}Al_{0.01}O₂ | LiVOPO₄ | 3 | 0.9 | 4 | 196 | 119 | A |
| Example 16 | Li_{1.01}Ni_{0.8}Co_{0.05}Mn_{0.15}O₂ | LiVOPO₄ | 3 | 0.9 | 4 | 188 | 101 | A |
| Example 17 | Li_{1.01}Ni_{0.8}Co_{0.1}Mn_{0.1}O₂ | LiVOPO₄ | 3 | 0.9 | 4 | 190 | 104 | A |
| Example 18 | Li_{1.01}Ni_{0.8}Co_{0.05}Mn_{0.15}O₂ | LiVOPO₄ | 5 | 1 | 4 | 186 | 101 | A |
| Example 19 | Li_{1.01}Ni_{0.8}Co_{0.05}Mn_{0.15}O₂ | LiVOPO₄ | 1.3 | 0.65 | 4 | 187 | 119 | A |
| Example 20 | Li_{1.01}Ni_{0.8}Co_{0.05}Mn_{0.15}O₂ | LiVOPO₄ | 3 | 0.9 | 2.33 | 187 | 97 | A |
| Example 21 | Li_{1.01}Ni_{0.8}Co_{0.05}Mn_{0.15}O₂ | LiVOPO₄ | 3 | 0.9 | 1.9 | 195 | 114 | A |

From Table 4, it is seen that high discharge capacity was obtained and heat generating peak strength was small also when LiNiCoAlO₂ or LiNiCoMnO₂ with different compositions was used as the first active material. It is also seen that even when LiNiCoMnO₂ was used, high discharge capacity was obtained and heat generating peak strength was small when the ratio a/b was in the range of 1≦a/b≦60 and the ratio c/d was in the range of 1.5≦c/d≦199.

### Example 22, Examples 34 and 35, Comparative Examples 7 and 8

In Example 22, Examples 34 and 35, and Comparative Examples 7 and 8, the battery cell was fabricated and evaluated by the same method as in Example 1 with the exception that the composition of the second active material was modified. The results are shown in Table 5.

TABLE 5

| | | | | | | Heat | |
|---|---|---|---|---|---|---|---|
| | | Second | | | Discharge | generating | |
| | | active | | b | capacity | peak | |
| | First active material | material | a/b | [μm] | [mAh/g] | intensity | Decision |
| Comparative | Li_{1.01}Ni_{0.8}Co_{0.15}Al_{0.05}O₂ | VOPO₄ | 3 | 0.3 | 175 | 138 | F |
| Example 7 | | | | | | | |
| Example 34 | Li_{1.01}Ni_{0.8}Co_{0.15}Al_{0.05}O₂ | Li_{0.1}VOPO₄ | 3 | 0.3 | 182 | 112 | A |
| Example 22 | Li_{1.01}Ni_{0.8}Co_{0.15}Al_{0.05}O₂ | Li_{0.5}VOPO₄ | 3 | 0.3 | 185 | 101 | A |
| Example 35 | Li_{1.01}Ni_{0.8}Co_{0.15}Al_{0.05}O₂ | Li_{1.2}VOPO₄ | 3 | 0.3 | 187 | 117 | A |
| Comparative | Li_{1.01}Ni_{0.8}Co_{0.15}Al_{0.05}O₂ | Li_{1.3}VOPO₄ | 3 | 0.3 | 179 | 140 | F |
| Example 8 | | | | | | | |

From Table 5, it is seen that when the second active material was outside the range of composition formula (2), discharge capacity was decreased and heat generating peak strength was increased.

LiₐVOPO₄ (2)

where 0<α≦1.2.

### Example 23 to Example 29

In Example 23 to Example 29, the battery cell was fabricated and evaluated by the same method as in Example 1 with the exception that the ratio of the combined mass e of the first active material and the second active material to the mass f of carbon material was modified. The results are shown in Table 6.

TABLE 6

| | | | | | Heat | |
|---|---|---|---|---|---|---|
| | | Second | | Discharge | generating | |
| | | active | | capacity | peak | |
| | First active material | material | e/f | [mAh/g] | intensity | Decision |
| Example 23 | Li_{1.01}Ni_{0.8}Co_{0.15}Al_{0.05}O₂ | LiVOPO₄ | 3 | 180 | 116 | A |
| Example 24 | Li_{1.01}Ni_{0.8}Co_{0.15}Al_{0.05}O₂ | LiVOPO₄ | 4 | 188 | 99 | A |
| Example 25 | Li_{1.01}Ni_{0.8}Co_{0.15}Al_{0.05}O₂ | LiVOPO₄ | 5.67 | 189 | 101 | A |
| Example 26 | Li_{1.01}Ni_{0.8}Co_{0.15}Al_{0.05}O₂ | LiVOPO₄ | 9 | 189 | 100 | A |
| Example 27 | Li_{1.01}Ni_{0.8}Co_{0.15}Al_{0.05}O₂ | LiVOPO₄ | 49 | 190 | 104 | A |
| Example 28 | Li_{1.01}Ni_{0.8}Co_{0.15}Al_{0.05}O₂ | LiVOPO₄ | 99 | 189 | 103 | A |
| Example 29 | Li_{1.01}Ni_{0.8}Co_{0.15}Al_{0.05}O₂ | LiVOPO₄ | 199 | 180 | 117 | A |

From Table 6, it is seen that when the positive electrode active material included the first active material and the second active material and further contained the carbon material, high discharge capacity was obtained and heat generating peak strength was small. It is also seen that when the ratio e/f of the combined mass e of the first active material and the second active material to the mass f of carbon material was in a range of 4≦e/f≦99, particularly high discharge capacity was obtained and heat generating peak strength was small.

### Examples 36 to 39

In Examples 36 to Example 39, the battery cell was fabricated and evaluated by the same method as in Example 1 with the exception that the first active material was modified. The results are shown in Table 7.

TABLE 7

| | | | | | | | Heat | |
|---|---|---|---|---|---|---|---|---|
| | | Second | | | | Discharge | generating | |
| | | active | | a | | capacity | peak | |
| | First active material | material | a/b | [μm] | c/d | [mAh/g] | intensity | Decision |
| Example 36 | Li_{1.01}Ni_{0.83}Co_{0.14}Al_{0.03}O₂ | LiVOPO₄ | 3 | 0.9 | 4 | 199 | 117 | A |
| Example 37 | Li_{1.01}Ni_{0.5}Co_{0.2}Mn_{0.3}O₂ | LiVOPO₄ | 3 | 0.9 | 4 | 186 | 99 | A |
| Example 38 | Li_{1.01}Ni_{0.6}Co_{0.2}Mn_{0.2}O₂ | LiVOPO₄ | 3 | 0.9 | 4 | 188 | 105 | A |
| Example 39 | Li_{1.01}Ni_{0.33}Co_{0.33}Mn_{0.33}O₂ | LiVOPO₄ | 3 | 0.9 | 4 | 184 | 95 | A |

From Table 7, it is seen that high discharge capacity was obtained and heat generating peak strength was small also when LiNiCoAlO₂ or LiNiCoMnO₂ with different compositions was used as the first active material.

As will be seen from the above evaluation results, it can be confirmed that the Examples provide higher discharge capacity than the Comparative Examples, and have small heat generating peak strengths.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A positive electrode active material for a lithium ion secondary battery, the material comprising:
a first active material selected from active materials represented by composition formula (1); and
a second active material represented by composition formula (2), wherein
a ratio a/b of an average particle diameter a of the first active material to an average particle diameter b of the second active material is in a range of 1≦a/b≦60, wherein
Li_{w}Niₓ(M1)_{y}(M2)_{z}O₂ (1)
where M1 is at least one element selected from Co and Mn, M2 is at least one element selected from Al, Fe, Cr, Ba, Mn, and Mg, 0.9<w<1.1, 2.0<(x+y+z+w)≦2.1, 0.3<x<0.95, 0.01<y<0.4, and 0.001<z<0.2, and
LiₐVOPO₄ (2)
where 0<α≦1.2.

2. The positive electrode active material for a lithium ion secondary battery according to claim 1, wherein
the ratio a/b of the average particle diameter a of the first active material to the average particle diameter b of the second active material is in a range of 1.3≦a/b≦5.

3. The positive electrode active material for a lithium ion secondary battery according to claim 1, wherein
a ratio c/d of a mass c of the first active material to a mass d of the second active material is in a range of 1.5≦c/d ≦199.

4. The positive electrode active material for a lithium ion secondary battery according to claim 1, further comprising a carbon material.

5. The positive electrode active material for a lithium ion secondary battery according to claim 4, wherein
a ratio e/f of a combined mass e of the first active material and the second active material to a mass f of the carbon material is in a range of 4≦e/f≦99.

6. A lithium ion secondary battery positive electrode comprising the positive electrode active material for a lithium ion secondary battery according to claim 1.

7. A lithium ion secondary battery comprising;
the lithium ion secondary battery positive electrode according to claim 6;
a negative electrode;
a separator; and
an electrolyte solution.
